(19) United States
(12) Patent Application Publication
(10) Pub. No.: US 2019/0129348 A1
(43) Pub. Date: May 2, 2019

(54) IMAGE FORMING APPARATUS AND IMAGE FORMING SYSTEM

(71) Applicant: TOSHIBA TEC KABUSHIKI KAISHA, Tokyo (JP)

(72) Inventor: Kimie KAMATA, Sunto Shizuoka (JP)

(21) Appl. No.: 16/052,346

(22) Filed: Aug. 1, 2018

(30) Foreign Application Priority Data
Oct. 26, 2017 (JP) 2017-207111

(51) Int. Cl. G03G 15/00

(52) U.S. Cl. CPC G03G 15/6582; G03G 15/6561

(57) ABSTRACT

An image forming apparatus in an example comprises a sheet supply section configured to supply a sheet to a sheet conveyance path, and a cover supply section configured to supply a cover to the sheet conveyance path. The cover is designed to cover at least a part of a peripheral portion of the sheet. A registration roller is on the sheet conveyance path presses the cover onto the sheet to form a laminated body. A sensor detects the cover and the sheet at the registration roller and issues a detection signal. A controller is configured to drive the registration roller according to the detection signal to form the laminated body. An image forming section forms an image on the sheet of the laminated body. A fixing section on the sheet conveyance path heats the laminated body to fix the image onto the sheet.

### CROSS-REFERENCE TO RELATED APPLICATION

This application is based upon and claims the benefit of priority from Japanese Patent Application No. 2017-207111, filed Oct. 26, 2017, the entire contents of which are incorporated herein by reference.

### FIELD

Embodiments described herein relate generally to an image forming apparatus and an image forming system.

### BACKGROUND

An image forming apparatus can form an image on a sheet. The sheet may be a label sheet (label paper). The label sheet comprises a surface base material and a release paper. The surface base material and the release paper are affixed to one another with an adhesive. In an image forming apparatus, if an image is being formed on a label sheet, the label sheet will be heated and pressed by a fixing device or the like, and in this way, the adhesive may extrude from an edge of the label sheet in some cases. There is a case in which a slight amount of the adhesive that protrudes from the edge of the sheet adheres to a conveyance guide, a conveyance roller, or the like in an image forming apparatus. If such adhesive is accumulated on the conveyance guide, the conveyance roller, or the like, there is a possibility that a sheet will jam on the conveyance path.

### DESCRIPTION OF THE DRAWINGS

FIG. 1 is a diagram illustrating a configuration of an image forming system including an image forming apparatus according to an embodiment.

FIG. 2 is a diagram illustrating a configuration of a part of the image forming apparatus.

FIG. 3 is a diagram illustrating a configuration of a registration roller.

FIG. 4 is a schematic diagram illustrating an example of a label sheet.

FIG. 5 is a schematic diagram illustrating an example of a cover.

FIG. 6 is a schematic diagram illustrating a structure of a post-processing apparatus.

FIG. 7 is a schematic diagram illustrating another example of the cover.

FIG. 8 is a schematic diagram illustrating an operation of the cover.

### DETAILED DESCRIPTION

In accordance with an embodiment, an image forming apparatus comprises a sheet supply section configured to supply a sheet to a sheet conveyance path, and a cover supply section configured to supply a cover to the sheet conveyance path. The cover is configured to cover at least a part of a peripheral portion of the sheet, such as the outer perimeter of the sheet or the like. A registration roller is on the sheet conveyance path and configured to press the cover onto the sheet to form a laminated body. A sensor is configured to detect the cover and the sheet at the registration roller and issue a detection signal. A controller is configured to drive the registration roller according to the detection signal to form the laminated body. An image forming section is configured to form an image on the sheet of the laminated body. A fixing section is on the sheet conveyance path and configured to heat the laminated body to fix the image onto the sheet.

Hereinafter, an image forming apparatus and an image forming system of example embodiments will be described with reference to the accompanying drawings.

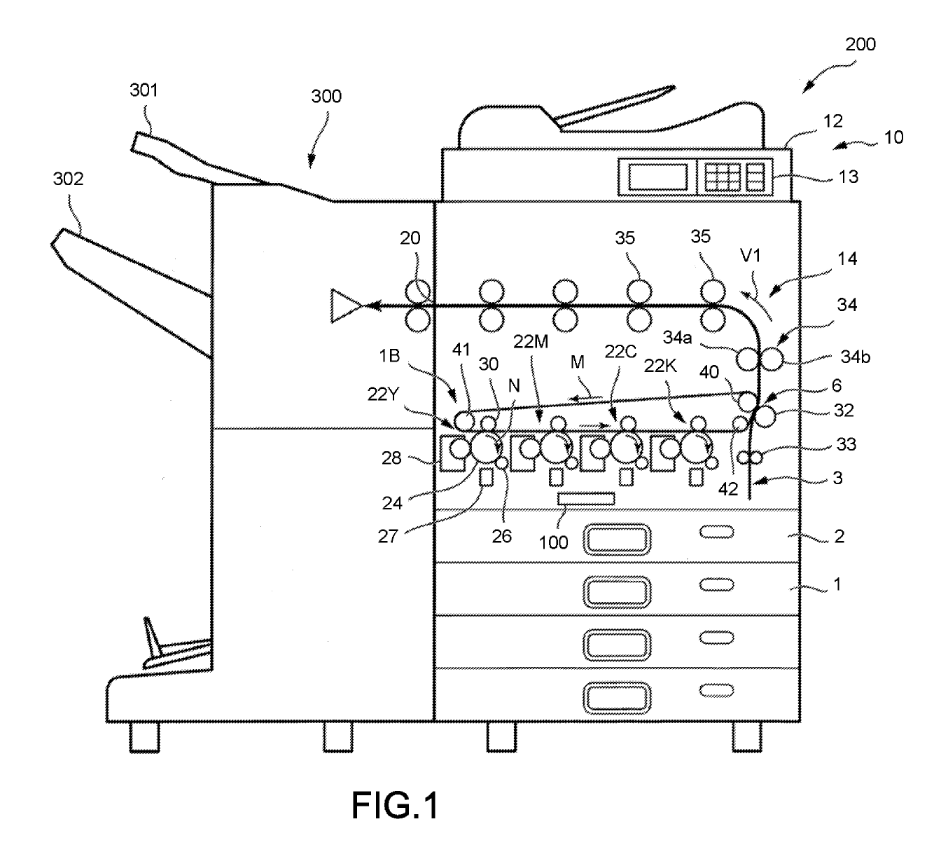

FIG. 1 is a diagram illustrating a configuration of an image forming system 200 incorporating an image forming apparatus 10 according to an embodiment. The image forming system 200 includes an image forming apparatus 10 and a post-processing apparatus 300. Hereinafter, a Multi-Function Peripheral (MFP) 10 is described as one possible example of an image forming apparatus 10.

As shown in FIG. 1, the MFP 10 includes a scanner 12, a control panel 13, and a main body section 14. The scanner 12 reads a document image. The control panel 13 includes input keys and a display section. For example, the input keys receive an input from a user. The scanner 12, the control panel 13 and the main body section 14 are each provided with a controller. The MFP 10 includes a system controller 100 for controlling these controllers.

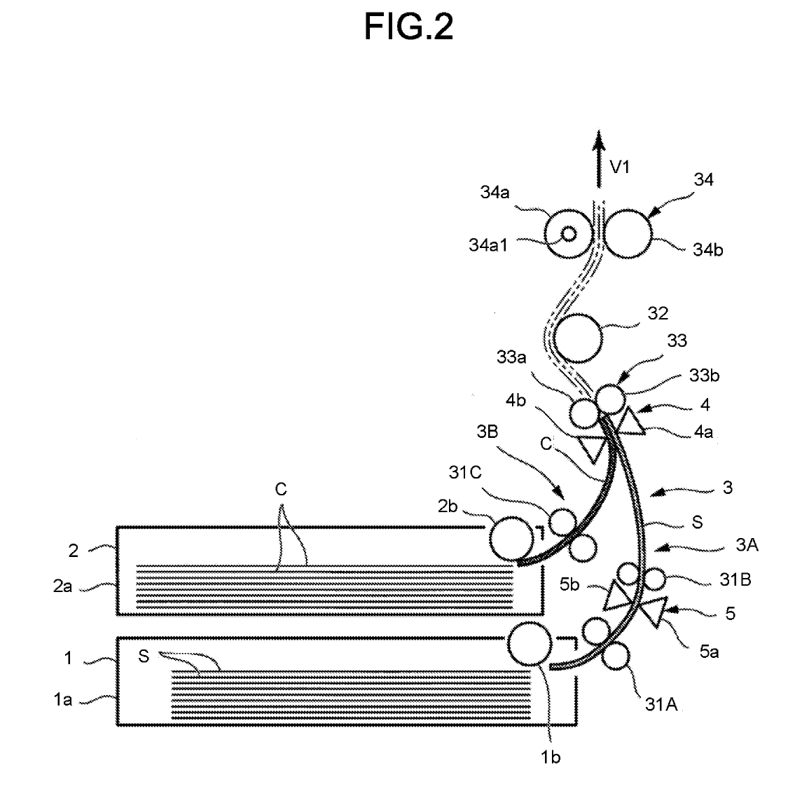

The main body section 14 includes a sheet feed section 1, a cover supply section 2, a conveyance section 3, a first sensor 4 (refer to FIG. 2), a second sensor 5 (refer to FIG. 2), and a printer section 18.

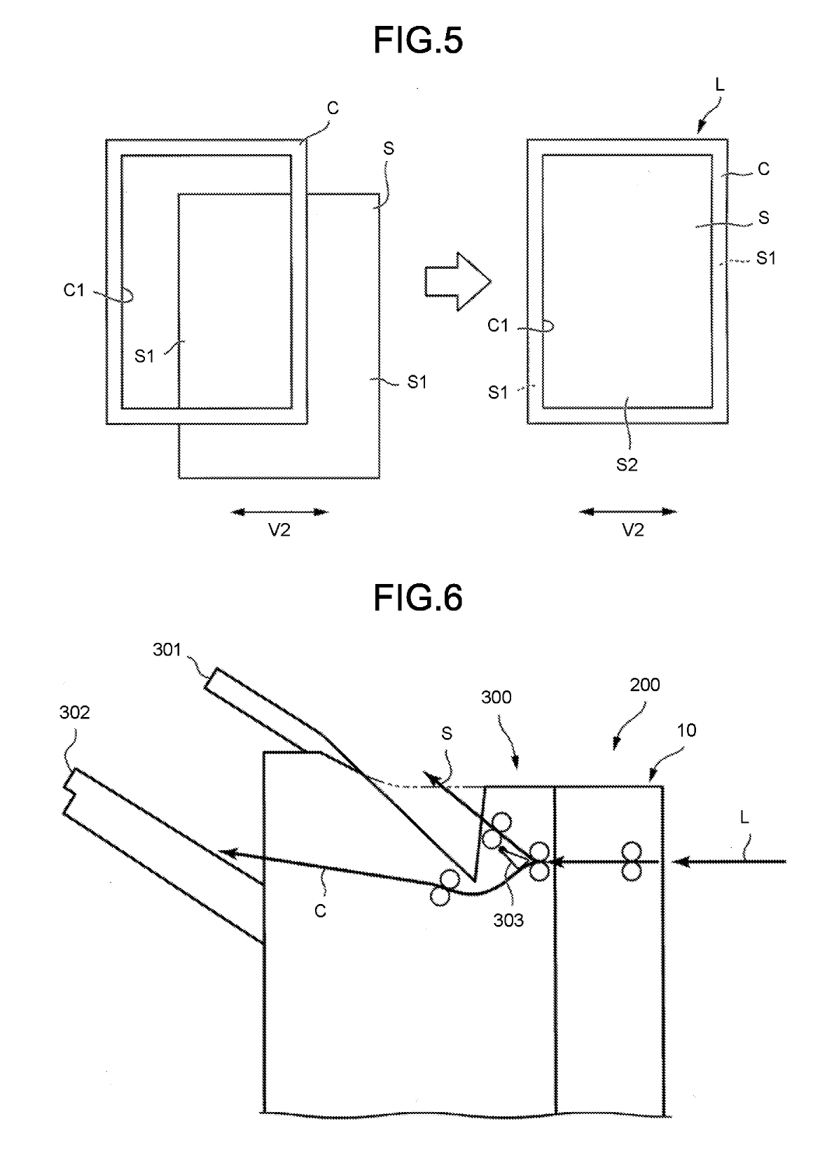

FIG. 2 is a diagram illustrating a configuration of a portion of the MFP 10. In the following description, a conveyance direction V1 is the conveyance direction of sheets S and the covers C along a path from the sheet feed section. A width direction V2 (refer to FIG. 5) is parallel to the surface of the sheet S and orthogonal to the conveyance direction V1. As shown in FIG. 1, along the conveyance direction V1 the end or portion of an element nearer the sheet feed section 1 or the cover supply section 2 is referred to as an “upstream side”. Along the conveyance direction V1, the end or portion of an element nearer the sheet discharge section 20 (refer to FIG. 1) is referred to as a “downstream side”.

As shown in FIG. 2, the sheet feed section 1 includes a sheet feed cassette 1a and a pickup roller 1b. The sheet feed cassette 1a accommodates a plurality of sheets S, which are considered image receiving media. The sheet S may be a label sheet. The pickup roller 1b abuts against the uppermost sheet S stacked in the sheet feed cassette 1a to send out a sheet S from the sheet feed cassette 1a to the conveyance section 3.

The cover supply section 2 includes a cover supply cassette 2a and a pickup roller 2b. The cover supply cassette 2a accommodates a plurality of covers C. The pickup roller 2b abuts against the uppermost cover C in the cover supply cassette 2a to send out a cover C from the cover supply cassette 2a to the conveyance section 3.

The conveyance section 3 has a sheet conveyance path 3A, a cover conveyance path 3B, and a registration roller set 33. The sheet conveyance path 3A includes a first sheet conveyance roller 31A and a second sheet conveyance roller 31B. The cover conveyance path 3B includes a cover conveyance roller 31C.

The first sheet conveyance roller 31A and the second sheet conveyance roller 31B transport the sheets S taken out from the sheet feed section 1 towards the registration roller set 33. The second sheet conveyance roller 31B is arranged on the downstream side in the conveyance direction of the sheets S with respect to the first sheet conveyance roller 31A.

The cover conveyance roller 31C transports the covers C taken out from the cover supply section 2 towards the registration roller set 33.

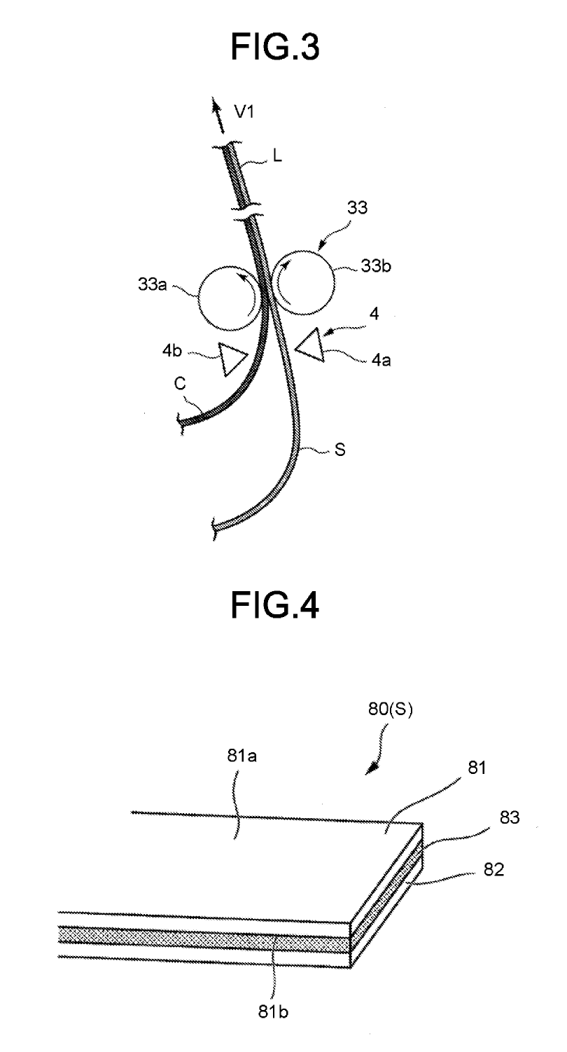

FIG. 3 is a diagram illustrating a configuration of the registration roller set 33. As shown in FIG. 3, the registration roller set 33 includes a first roller 33a and a second roller 33b. In the registration roller set 33, a cover C and a sheet S are laminated between the first roller 33a and the second roller 33b to become a sheet laminated body L. The first roller 33a and the second roller 33b are rotationally driven by a driving source (not shown). The registration roller set 33 conveys the sheet laminated body L towards the transfer section 6 (refer to FIG. 1).

The system controller 100 controls the rotational driving and stopping of the first roller 33a and the second roller 33b.

As shown in FIG. 2, the first sensor 4 is located in the vicinity of the registration roller set 33 at a position on the upstream side of the cover C with respect to the registration roller set 33.

The first sensor 4 detects the cover C. For example, the first sensor 4 is an optical sensor. The first sensor 4 includes a light emitting section 4a and a light receiving section 4b. The light emitting section 4a emits light. The light receiving section 4b receives the light from the light emitting section 4a. For example, the light emitting section 4a is a LD (Laser Diode), a LED (Light Emitting Diode), or the like. For example, the light receiving section 4b is a PD (photodiode) or the like. The light emitting section 4a and the light receiving section 4b are arranged to face each other across the conveyance path of the cover C. If the light emitted from the light emitting section 4a is blocked by the cover C, the light receiving section 4b sends a first detection signal to the system controller 100. The first sensor 4 is not limited to an optical sensor, and may be a microswitch including an actuator, for example.

The second sensor 5 is provided between the first sheet conveyance roller 31A and the second sheet conveyance roller 31B. The second sensor 5 detects the sheet S. For example, the second sensor 5 is an optical sensor. The second sensor 5 includes a light emitting section 5a and a light receiving section 5b.

The light emitting section 5a emits light. The light receiving section 5b receives the light from the light emitting section 5a. For example, the light emitting section 5a is a LD, a LED or the like. For example, the light receiving section 5b is a PD or the like. The light emitting section 5a and the light receiving section 5b are arranged to face each other across the conveyance path of the sheet S. If the light emitted from the light emitting section 5a is blocked by the sheet S, the light receiving section 5b sends a second detection signal to the system controller 100. The second sensor 5 is not limited to the optical sensor, and may be a microswitch including an actuator, for example.

The printer section 18 forms an image on the sheet S. For example, the printer section 18 executes image formation based on a document image read with the scanner 12. The printer section 18 is provided with an intermediate transfer belt 21. The printer section 18 supports the intermediate transfer belt 21 with a backup roller 40, a driven roller 41 and a tension roller 42. The backup roller 40 is provided with a driving section (not shown). The printer section 18 rotates the intermediate transfer belt 21 in the arrow M direction.

The printer section 18 includes set of four image forming stations 22Y, 22M, 22C and 22K. The image forming stations 22Y, 22M, 22C and 22K are used to form Y (yellow), M (magenta), C (cyan) and K (black) images, respectively. The image forming stations 22Y, 22M, 22C and 22K are arranged in parallel along a traveling direction of the intermediate transfer belt 21.

The image forming station 22Y (yellow) is described as an example, the image forming stations 22M, 22C and 22K have substantially the same structure as the image forming station 22Y, and detailed description is omitted.

The image forming station 22Y includes a photoconductive drum 24 (photoconductor), an electrostatic charger 26, an exposure scanning head 27, a developing device 28, and a primary transfer roller 30. The electrostatic charger 26, the exposure scanning head 27, and the developing device 28 are arranged proximate to the photoconductive drum 24. The photoconductive drum 24 rotates in the arrow N direction.

The image forming station 22Y includes a primary transfer roller 30. The primary transfer roller 30 faces the photoconductive drum 24 across the intermediate transfer belt 21. The image forming station 22Y exposes the photoconductive drum 24 with the exposure scanning head 27 after the photoconductive drum 24 has been charged by the electrostatic charger 26. The image forming station 22Y forms an electrostatic latent image on the photoconductive drum 24. The developing device 28 uses a two-component developing agent, composed of a toner and a carrier, to develop the electrostatic latent image on the photoconductive drum 24.

The primary transfer roller 30 first transfers a toner image formed on the photoconductive drum 24 onto the intermediate transfer belt 21. The image forming stations 22Y, 22M, 22C and 22K collectively form a color toner image on the intermediate transfer belt 21 with the primary transfer roller 30. The color toner image is formed by overlapping separate Y, M, C and K toner images.

The printer section 18 includes a transfer section 6. The transfer section 6 includes a backup roller 40 and a secondary transfer roller 32. The secondary transfer roller 32 faces the backup roller 40 across the intermediate transfer belt 21. The secondary transfer roller 32 transfers the color toner image formed on the intermediate transfer belt 21 onto the sheet S.

The printer section 18 includes a fixing section 34. The fixing section 34 includes a heat roller 34a and a pressure roller 34b. The heat roller 34a includes a heating section 34a1 (refer to FIG. 2) therein. For example, the heating section 34a1 is a heater lamp, an inductive heater (IH) heater, or the like. The pressure roller 34b presses the sheet laminated body L between the pressure roller 34b and the heat roller 34a. The fixing section 34 fixes the toner image on the sheet S by applying heat and pressure with the heat roller 34a and the pressure roller 34b.

The heat roller 34a is arranged to be on the cover C side of the sheet laminated body L. Thereby, the effect of any heat shielding provided by the cover C can be enhanced, and yet the printing surface of the sheet Scan still be efficiently heated.

In the MFP 10, the printer section 18 forms a fixed toner image on the sheet S. The MFP 10 sends the sheet S after toner image fixing to the sheet discharge section 20.

Next, aspects of the sheet S are described. The sheet S may be a label sheet. FIG. 4 is a schematic diagram illustrating an example of a label sheet. As shown in FIG. 4, a label sheet 80 includes a surface base material 81, an adhesive layer 83, and a release paper 82. One surface (referred to as a first surface) of the surface base material 81 is a printing surface 81a. The opposite surface (referred to as a second surface) of the surface base material 81 is a pasting surface 81b. The release paper 82 is adhered to the pasting surface 81b in a peelable manner by the adhesive layer 83. For example, the shape of the label sheet 80 in a plan view is rectangular. For example, the label sheet 80 is a sheet having a standardize shape and size such as A4, B5, or the like.

Next, aspects of the cover C are described. FIG. 5 is a schematic diagram illustrating an example of a cover C. Cover C is a sheet-like object having a rectangular frame shape having a rectangular window part C1 in a plan view. The cover C overlaps with the sheet S to cover the entire outer circumference of a peripheral part S1 of a sheet S. For example, the outer dimensions of the cover C are the same as the outer dimensions of the sheet S to which it is to be matched. Therefore, in a state in which the cover C is superimposed on the sheet S, a peripheral part of the cover C and the peripheral part S1 of the sheet S will be aligned in a plan view. The window part C1 of the cover C exposes a central area S2 of the sheet S. The central area S2 is the area of the sheet S excluding the peripheral part S1 and remains uncovered by the cover C when the cover C has been superimposed on the sheet S. The cover C is placed on the printing surface 81a side of the surface base material 81 of the label sheet 80 (refer to FIG. 4). For example, the thickness of the cover C may be 0.1 to 0.5 mm.

A thermal conductivity of the cover C is preferably lower than that of the sheet S. The thermal conductivity in this context can be measured according to Japanese Industrial Standard (JIS) R 2606 (2001). For measurement of the thermal conductivity, a rapid thermal conductivity meter such as a QTM-500 rapid thermal conductivity meter (manufactured by Kyoto Electronics Manufacturing Co., Ltd.) can be used. As the material of the cover C, a resin such as polyurethane (for example, urethane foam), polyethylene, polypropylene or the like can be provided. The material of the cover C may be silica aerogel or the like. For example, the thermal conductivity of a urethane foam is 0.021 W/(m*K). The thermal conductivity of a silica aerogel is 0.02 W/(m*K). For comparison, the thermal conductivity of general-purpose paper is about 0.05 W/(m*K).

FIG. 6 is a schematic diagram illustrating a post-processing apparatus 300. The post-processing apparatus 300 executes a post-processing on a sheet S conveyed from the MFP 10. For example, the post-processing is a stapling process, a punching process, a folding process, a sorting process, a bookbinding process, or the like. The post-processing apparatus 300 includes a first discharge section 301, a second discharge section 302, and a separation section 303. For example, the separation section 303 is a plate-like member. The separation section 303 separates any sheet laminated body L conveyed from the MFP 10 into the sheet S and the cover C components, and then guides the separated sheet S to the first discharge section 301. The separation section 303 guides the separated cover C to the second discharge section 302.

Next, an example of the operation of the MFP 10 is described.

As shown in FIG. 2, the system controller 100 stops the first roller 33a and the second roller 33b of the registration roller set 33.

The pickup roller 2b of the cover supply section 2 then takes out a cover C from the cover supply section 2. The cover conveyance roller 31C sends the cover C to the registration roller set 33. The cover C abuts against the first roller 33a and the second roller 33b and stops. The first sensor 4 detects the cover C and sends the first detection signal to the system controller 100.

The pickup roller 1b of the sheet feed section 1 now takes out a sheet S from the sheet feed section 1. The first sheet conveyance roller 31A and the second sheet conveyance roller 31B convey the sheet S. The second sensor 5 detects the sheet S and sends the second detection signal to the system controller 100. The sheet S abuts against the first roller 33a and the second roller 33b and stops. As a result, at least a part of the sheet S and the cover C are superimposed with each other.

Based on the first detection signal and the second detection signal, the system controller 100 determines that the sheet S has been superimposed on the cover C. For example, the system controller 100 can determine that the sheet S has reached the registration roller set 33 and is superimposed on the cover C after a predetermined time elapses after reception of the second detection signal.

As shown in FIG. 3, the system controller 100 rotationally drives the first roller 33a and the second roller 33b to convey the sheet laminated body L towards the transfer section 6 (refer to FIG. 1).

As shown in FIG. 1, in the transfer section 6, the secondary transfer roller 32 transfers the color toner image from the intermediate transfer belt 21 onto the sheet S. At this time, the toner image on the intermediate transfer belt 21 is transferred onto the center area S2 of the sheet S left exposed by the window part C1 of the cover C (refer to FIG. 5). The intermediate transfer belt 21 and the secondary transfer roller 32 convey the sheet laminated body L to the fixing section 34.

The fixing section 34 fixes the image by applying heat and pressure to the sheet S of the sheet laminated body L with the heat roller 34a and the pressure roller 34b (refer to FIG. 2). The conveyance roller 35 conveys the sheet laminated body L after it has been subjected to an image fixing operation to the paper discharge section 20.

As shown in FIG. 6, the sheet laminated body L that has been discharged by the sheet discharge section 20 is separated into a sheet S and a cover C by the separation section 303 of the post-processing apparatus 300. The separated sheet S is conveyed to the first discharge section 301. The separated cover C is conveyed to the second discharge section 302.

In the MFP 10 of an embodiment, the heat applied to the peripheral part S1 of the sheet S in the laminated body L in the fixing section 34 is reduced as compared with the case in which there is no cover C. Therefore, the adhesive hardly protrudes from the edges of the sheet S. Thereby, it is possible to limit fouling due to adhesion of the adhesive to the conveyance guide, the conveyance roller, and the like. Therefore, in the MFP 10 of an embodiment, jamming of sheets S is reduced substantially.

In the MFP 10, since the cover C is superimposed on the peripheral part S1 of the sheet S, the heat roller 34a of the fixing section 34 does not directly contact with the peripheral part S1 of the sheet S. Therefore, it is possible to reduce the amount of heat that is applied to the peripheral part S1 of the sheet S in the fixing section 34.

Modifications are described below.

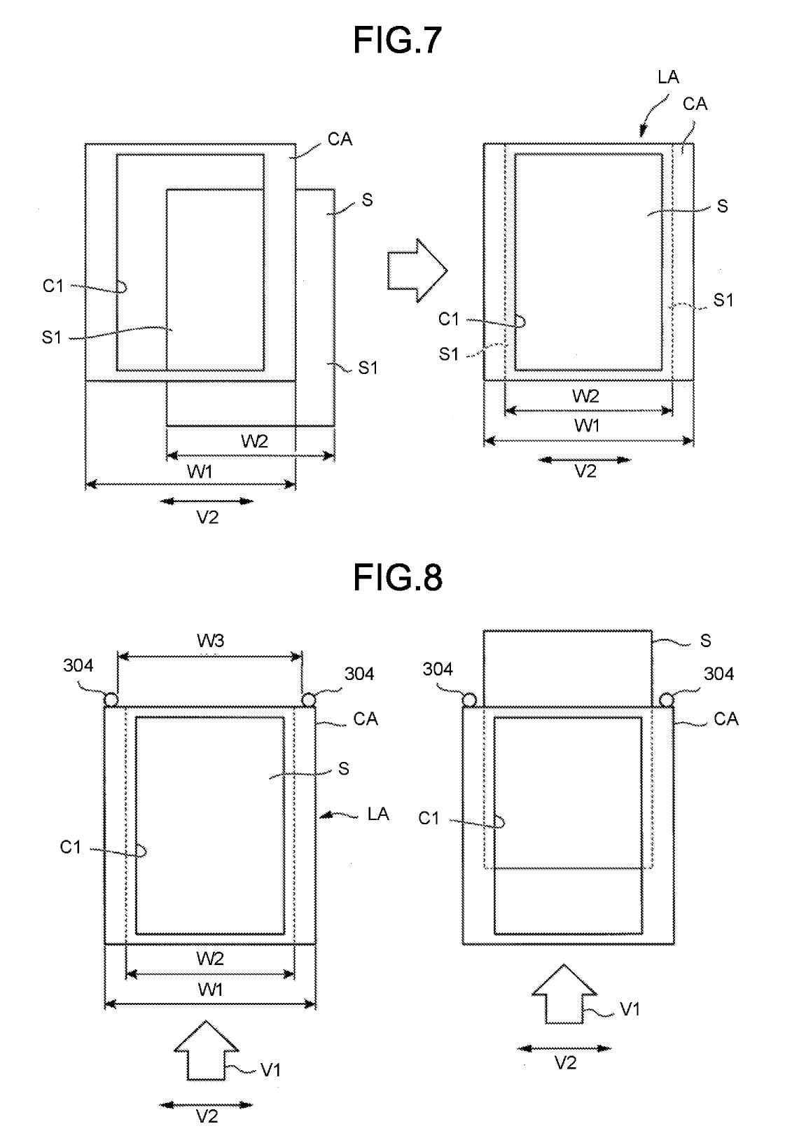

FIG. 7 is a schematic diagram of a cover CA, which is another example of the cover C. As shown in FIG. 7, a width W1 of the cover CA is larger than a width W2 of the sheet S. A sheet laminated body LA is constituted by superimposing the cover CA on the sheet S. The widths W1 and W2 are dimensions in the width direction V2.

As shown in FIG. 8, in the post-processing apparatus 300 (refer to FIG. 6), a pair of stoppers 304 may be used instead of the separation section 303. A separation distance W3 in the width direction V2 between the pair of stoppers 304 is smaller than the width W1 of the cover CA. The separation distance W3 is larger than the width W2 of the sheet S. The stopper 304 can abut against a portion of the cover CA which protrudes outward in the width direction V2 from the sheet S. The stopper 304 regulates the movement of the cover CA along the conveyance direction V1, but permits the movement of the sheet S. The sheet S is able to pass between the two stoppers 304 and thus be conveyed beyond the stoppers 304. As a result, the cover CA can be easily separated from the sheet S.

In general, a cover (e.g., cover C or cover CA) preferably covers the entire outer perimeter of the sheet S; however, in some embodiments, a cover may cover only some part of the outer perimeter the sheet S. In other words, a cover can be arbitrarily shaped so long as the shape covers at least a part of the outer perimeter of the sheet. In some variations, the image forming apparatus may directly transfer a toner image from a photoconductive drum onto a sheet S rather than transfer via an intermediate transfer belt or the like. In some embodiments, image forming apparatus may be an inkjet type image forming apparatus rather than toner-based image forming apparatus. In some embodiments, the sensor(s) used in the image forming apparatus may detect superimposition of a cover and a sheet based on differences in an optical transparency through a thickness direction of the cover when only the cover abuts against the registration roller and an optical transparency in the thickness direction of the sheet laminated body when the cover and the sheet abut against the registration roller. The roller that superimposes a cover on a sheet to form a sheet laminated body is not limited to the registration roller, and it may be a conveyance roller having a function of conveying the sheet. In this case, the conveyance roller is provided on the upstream side with respect to the transfer section.

According to at least one embodiment described above, the cover is superimposed on the peripheral part of the sheet, and in this way, the heat applied to the peripheral part of the sheet can be reduced in the fixing section. Therefore, extrusion of adhesive from the sheet S occurs substantially less. Thereby, it is possible to reduce problems caused by adhesion of label sheet adhesive onto the conveyance roller and the like. Therefore, the occurrence of paper jams and the like is reduced.

While certain embodiments have been described, these embodiments have been presented by way of example only, and are not intended to limit the scope of the present disclosure. Indeed, the novel embodiments described herein may be embodied in a variety of other forms; furthermore, various omissions, substitutions and changes in the form of the embodiments described herein may be made without departing from the spirit of the present disclosure. The accompanying claims and their equivalents are intended to cover such forms or modifications as would fall within the scope and spirit of the present disclosure.

What is claimed is:

1. An image forming apparatus, comprising:
a sheet supply section configured to supply a sheet to a sheet conveyance path;
a cover supply section configured to supply a cover to the sheet conveyance path, the cover being configured to cover at least a part of a peripheral portion of the sheet;
a registration roller on the sheet conveyance path and configured to press the cover onto the sheet to forma laminated body;
a sensor configured to detect the cover and the sheet at the registration roller and issue a detection signal;
a controller configured to drive the registration roller according to the detection signal to form the laminated body;
an image forming section configured to form an image on the sheet; and
a fixing section on the sheet conveyance path and configured to heat the laminated body to fix the image onto the sheet.

2. The image forming apparatus according to claim 1, wherein
the fixing section includes a heat roller configured to heat the laminated body and a pressure roller configured to press the laminated body between the pressure roller and the heat roller, and
the heat roller is on a cover side of the laminated body.

3. The image forming apparatus according to claim 2, wherein the cover has a frame shape that leaves a central area of the sheet exposed when the cover is on the sheet.

4. The image forming apparatus according to claim 1, wherein the cover has a frame shape that leaves a central area of the sheet exposed when the cover is on the sheet.

5. The image forming apparatus according to claim 1, wherein the cover covers the entirety of the peripheral portion of the sheet when the laminated body is formed at the registration roller.

6. The image forming apparatus according to claim 1, wherein the cover is frame-like.

7. The image forming apparatus according to claim 6, wherein the cover comprises portions which extend beyond an outer edge of the sheet in a sheet width direction that is perpendicular to the conveyance path.

8. The image forming apparatus according to claim 1, further comprising:
a post-processing apparatus configured to receive the laminated body after the laminated body has passed through the fixing section and to separate the laminated body into the sheet and the cover.

9. The image forming apparatus according to claim 1, further comprising:
a transfer section configured to transfer a toner image formed by the image forming section on an intermediate transfer belt to the laminated body.

10. The image forming apparatus according to claim 1, wherein the cover comprises a material having a lower thermal conductivity than a thermal conductivity of the sheet.

11. The image forming apparatus according to claim 1, wherein the cover comprises urethane foam.

12. An image forming apparatus comprising:
a sheet supply section configured to supply a sheet to a sheet conveyance path;
a cover supply section configured to supply a cover to the sheet conveyance path, the cover being configured to be superimposed on the sheet to cover at least a part of a peripheral portion of the sheet;
a registration roller on the sheet conveyance path and configured to press the cover onto the sheet to form a laminated body;
a sensor configured to detect the cover and the sheet at the registration roller and issue a detection signal;
a controller configured to drive the registration roller according to the detection signal to form the laminated body by passing the sheet and the cover through the registration roller simultaneously;
an image forming section configured to form a toner image on a transfer belt;
a transfer section configured to transfer the toner image from the transfer belt onto an image region of the sheet of laminated body to form an image on the sheet, the image region being left exposed by the cover; and
a fixing section on the sheet conveyance path and configured to heat the laminated body to fix the image onto the sheet.

13. The image forming apparatus according to claim 12, further comprising:
a post-processing apparatus configured to receive the laminated body after the laminated body has passed through the fixing section and to separate the laminated body into the sheet and the cover.

14. The image forming apparatus according to claim 12, wherein
the fixing section includes a heat roller configured to heat the laminated body and a pressure roller configured to press the laminated body between the pressure roller and the heat roller, and
the heat roller is on a cover side of the laminated body.

15. The image forming apparatus according to claim 12, wherein the cover is frame-like.

16. The image forming apparatus according to claim 15, wherein the cover comprises portions which extend beyond an outer edge of the sheet in a sheet width direction that is perpendicular to the conveyance path.

17. An image forming system, comprising:
an image forming apparatus; and
a post-processing apparatus configured to perform a post-processing operation on an output from the image forming apparatus, wherein
the image forming apparatus comprises:
a sheet supply section configured to supply a sheet to a sheet conveyance path;
a cover supply section configured to supply a cover to the sheet conveyance path, the cover being configured to cover at least a part of a peripheral portion of the sheet;
a registration roller on the sheet conveyance path and configured to press the cover onto the sheet to forma laminated body;
a sensor configured to detect the cover and the sheet at the registration roller and issue a detection signal;
a controller configured to drive the registration roller according to the detection signal to form the laminated body;
an image forming section configured to form an image on the laminated body; and
a fixing section on the sheet conveyance path and configured to heat the laminated body to fix the image; and
the output from the image forming apparatus is the laminated body and the post-processing operation comprises separating the laminated body into the sheet and the cover.

18. The image forming system according to claim 17, the image forming apparatus further comprising:
a transfer section configured to transfer a toner image formed by the image forming section on an intermediate transfer belt to the laminated body.

19. The image forming system according to claim 17, wherein the cover is frame-like and comprises portions which extend beyond an outer edge of the sheet in a sheet width direction that is perpendicular to the conveyance path.

20. The image forming system according to claim 19, wherein
the post-processing apparatus comprises:
a stopper configured to abut against at least one of the portions of the cover which extend beyond the outer edge of the sheet in the sheet width direction, and
the stopper separates the cover and the sheet from the laminated body.
